(19) United States
(12) Patent Application Publication
(10) Pub. No.: US 2015/0286620 A1
(43) Pub. Date: Oct. 8, 2015

(54) INTERACTIVE PROJECT MANAGEMENT

(71) Applicants: Viktor Teslenko, Kyiv (UA); Mykola Nikolaiev, Kyiv (UA)

(72) Inventors: Viktor Teslenko, Kyiv (UA); Mykola Nikolaiev, Kyiv (UA)

(21) Appl. No.: 14/679,157

(22) Filed: Apr. 6, 2015

Related U.S. Application Data
(60) Provisional application No. 61/976,091, filed on Apr. 7, 2014.

(51) Int. Cl. G06F 17/24; H04L 29/06

(52) U.S. Cl. CPC G06F 17/24; H04L 65/403

(57) ABSTRACT

Systems and methods for interactive project management. Features drawn by users on a virtual canvas are converted through the application of transforming rule sets into an action plan consisting of actions and causal relationships defining the order of those actions, or through the application of translating rule sets into secondary forms such as a virtual canvas, a task list, a narrative, a webpage, or a multimedia presentation. Action plans may be edited by multiple users contemporaneously and a server coordinates the edits such that each user maintains an identical and current copy of the action plan.

### CROSS-REFERENCE TO RELATED APPLICATIONS

The present application claims the benefit of co-pending U.S. provisional application No. 61/976,091 filed on Apr. 7, 2014, the entire disclosure of which is incorporated by reference as if set forth in its entirety herein.

### FIELD

The present invention is directed toward the field of collaboration and, in particular, to systems and methods for interactive project management.

### BACKGROUND

Since time immemorial, people have engaged in the planning of actions and the subsequent adjustment of those plans in order to achieve their goals. With the advent of modern computing technologies, it has become convenient to use computing devices to support the process of planning.

When it comes to coordinating the efforts of a group of people, it can be challenging to keep everyone in the group informed about the initial plan as well as updated with subsequent plan revisions. Hosted storage services can be used to provide team members with access to a planning document. However, if multiple users decide to contemporaneously edit that document, then there is the potential for one user's changes to overwrite or destroy another user's changes. Moreover, each user needs to be advised when those changes have been made.

In addition, current solutions for planning suffer from several known limitations. Task lists lack context and sequencing, fail to preserve a history of execution, and are generally speaking unsuitable for long-term planning. Like task lists, Kanban boards also lack context and are generally limited to short-term planning. Gantt charts require special training to use, as do PERT charts; in addition, PERT charts are limited to a particular methodology and require significant data entry.

Accordingly, there is a need for systems and methods that permit groups of users to create, track, revise and collaborate on action plans while avoiding versioning problems.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

The present invention represents a practical solution to the problem of creating long-term action plans, project plans, or roadmaps. Embodiments of the present invention allow users to visually create plans by drawing a diagram-like picture on a two-dimensional virtual canvas. This visual representation depicts a plurality of actions and a plurality of unidirectional causal relationships which express the order of execution of those actions. In the aggregate, these actions and their order of execution specify a flow or sequence.

The features drawn on a virtual canvas can be translated through the application of various rule sets into an action plan and from an action plan into various secondary forms, such as a virtual canvas, a tasklist, a narrative, a webpage, or a multimedia presentation. Once an action plan is created, that action plan can be edited and its status of execution tracked. Users can collaborate at the same time on creating and editing an action plan. The elements of an action plan (e.g., tasks, steps, actions, etc.) can be prioritized. Once established, action plans can be reused and shared with other users to facilitate future planning.

In one aspect, embodiments of the present invention relate to a method for interactive project management. The method includes providing a virtual canvas for receiving at least one drawn feature, receiving at least one feature drawn on the virtual canvas, and applying one of a plurality of transforming rule sets, each rule set for transforming the at least one drawn feature into an action plan. At least one of a plurality of translation rule sets is applied to translate the action plan into a secondary form, wherein the secondary form is selected from the group consisting of a virtual canvas, a task list, a narrative, a webpage, and a multimedia presentation. In one embodiment, the secondary form is specific to a user.

In one embodiment, the action plan is associated with an action plan rule set, the action plan rule set describing the structure of the action plan and how the action plan reacts to changes in the action plan.

In one embodiment, the secondary form is a virtual canvas and the translation rule set comprises a rule for creating a virtual canvas receiving drawn features from the action plan. In one embodiment, the secondary form is a task list, and the translation rule set comprises a rule for creating a list of tasks from the action plan.

In one embodiment, the secondary form is a narrative and the translation rule set comprises a rule translating the action plan into at least one illustrated text, and the method further comprises translating the action plan into at least one illustrated text in accord with the rule; the rule may further comprise formatting information for the at least one illustrated text.

In one embodiment, the secondary form is a web page and the translation rule set comprises a rule translating the action plan into a web page, and the method further comprises translating the at least one action into at least a portion of the web page in accord with the rule; the rule may further comprise formatting information for at least the portion of the web page.

In one embodiment, the secondary form is a multimedia presentation and the translation rule set comprises a rule translating the action plan into a multimedia presentation, and the method further comprises translating the at least one action into at least a portion of the multimedia presentation in accord with the rule; the rule may further comprise the definition of graphics, animation, sound, melody, scene, scenario, timing, dynamics, synchronization, or another aspect of multimedia content.

In another aspect, embodiments of the present invention relate to a system for interactive project management. The system includes an interface, a memory, and a processor. The interface is configured to provide a representation of a virtual canvas for receiving at least one drawn feature, and further configured to receive at least one feature drawn on the virtual canvas. The memory is configured to store a plurality of translation rule sets, each rule set for translating an action plan into a secondary form, and the memory is further configured to store a plurality of transforming rule sets for transforming the at least one received drawn feature into an action plan. The processor is configured to translate the at least one received drawn feature into an action plan by applying at least one of the plurality of transforming rule sets to the at least one received drawn feature, and the processor is further configured to apply one of the plurality of predetermined translation rule sets to translate the action plan into a secondary form, wherein the secondary form is selected from the group consisting of a virtual canvas, a task list, a narrative, a webpage, and a multimedia presentation. In one embodiment, the secondary form is specific to a user.

In one embodiment, the action plan is associated with an action plan rule set stored in the memory, the action plan rule set describing the structure of the action plan and how the processor should process changes in the action plan.

In one embodiment, the secondary form is a virtual canvas, and the translation rule set comprises a rule for creating a virtual canvas receiving drawn features from the action plan.

In one embodiment, the secondary form is a task list, and the translation rule set comprises a rule for creating a list of tasks from the action plan, and the processor is further configured to translate the action plan into a list of tasks in accord with the rule.

In one embodiment, the secondary form is a narrative and the translation rule set comprises a rule translating the action plan into at least one illustrated text, and the processor is further configured to translate the action plan into at least one illustrated text in accord with the rule; the rule may further include formatting information for the at least one illustrated text.

In one embodiment, the secondary form is a web page and the translation rule set comprises a rule translating the action plan into a web page, and the processor is further configured to translate the action plan into at least a portion of the web page in accord with the rule; the rule may further comprise formatting information for at least the portion of the web page.

In one embodiment, the secondary form is a multimedia presentation and the translation rule set comprises a rule translating the action plan into a multimedia presentation, and the processor is further configured to translate the action plan into at least a portion of the multimedia presentation in accord with the rule; the rule may further comprise the definition of graphics, animation, sound, melody, scene, scenario, timing, dynamics, synchronization, or timedia content.

These and other features and advantages, which characterize the present non-limiting embodiments, will be apparent from a reading of the following detailed description and a review of the associated drawings. It is to be understood that both the foregoing general description and the following detailed description are explanatory only and are not restrictive of the non-limiting embodiments as claimed.

### BRIEF DESCRIPTION OF DRAWINGS

Non-limiting and non-exhaustive embodiments are described with reference to the following Figures in which:

FIG. 1 is a block diagram illustrating an overview of the operation of an embodiment of the present invention;

FIG. 2 is a block diagram of one embodiment of a system in accord with the present invention;

FIG. 3 is a block diagram illustrating exemplary interaction between a user and an embodiment of the invention;

FIG. 4 is an example of an action plan canvas with some actions depicted;

FIG. 5 is an example of an action plan canvas with causal relationships established between actions;

FIG. 6 depicts the decomposition of individual actions and lower-level spaces in accord with the present invention;

FIG. 7 presents examples of sub-level actions;

FIG. 8 shows the creation of draft actions using the present invention;

FIG. 9 shows a list of actions generated from an action canvas;

FIG. 10 depicts several examples of user-created actions;

FIG. 11 illustrates an example of action copying;

FIG. 12 presents another example of action copying;

FIG. 13 depicts an example of action plan export as an image;

FIG. 14 shows an example of action plan export as a webpage;

FIG. 15 illustrates an example of a user's action plan;

FIG. 16 presents an example of a task list;

FIG. 17 shows a task list with subsections;

FIG. 18 presents another example of a user's action plan;

FIG. 19 presents an example of a user's action plan with deadlines and assignees;

FIG. 20 shows how each action may be associated with action details;

FIG. 21 presents a status bar in one embodiment of the present invention;

FIG. 22 shows an example of users in an action plan;

FIG. 23 depicts user-specific action plan views;

FIG. 24 shows how files can be associated with an action plan;

FIG. 25 illustrates how a plurality of action plans can be organized in a workspace;

FIG. 26 presents users in a workspace;

FIG. 27 depicts how changes from a single user may be saved in an action plan;

FIG. 28 shows how changes from multiple users may be saved in an action plan; and

FIG. 29 presents an example of a method for interactive project management in accord with the present invention.

In the drawings, like reference characters generally refer to corresponding parts throughout the different views. The drawings are not necessarily to scale, emphasis instead being placed on the principles and concepts of operation.

### DETAILED DESCRIPTION

It is advantageous to define several terms before describing the invention. It should be appreciated that the following terms are used throughout this application.

### DEFINITIONS

For the purposes of the present invention, the term “action” refers to a piece of data which describes any possible logical entity that can be planned, such as an activity, task, aim, goal, milestone, stage, state, control point, etc. An action may have a title, description, type, status, state, coordinates, action group identifier, textual or graphical notes, and other properties including dates, deadlines, locations, durations, numbers, amounts, assigned people and any other data. An action may also include references to files, URLs, and other addresses.

For the purposes of the present invention, the term “causal relationship” refers to a piece of data which describes a unidirectional tie between two actions and defines the order in which those two actions are supposed to be executed.

For the purposes of the present invention, the term “action plan” refers to a document which includes at least one action. Action plans that include at least two actions may optionally have at least one causal relationship defined between some of those actions. An action plan also may also have a title, description, textual or graphical notes, and other properties including dates, deadlines, locations, durations, numbers, amounts, assigned people and any other similar data. An action plan may also contain references to files, URLs, and other addresses.

### DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

In brief overview, embodiments of the present invention allow users to graphically interact with a two-dimensional canvas, drawing various features on the canvas. A rule set selected from a plurality of transformation rule sets may be applied to convert the drawn features into an action plan. The action plan may, in turn, be converted into a secondary form, such as a virtual canvas, a task list, an action plan, a narrative, a webpage, and a multimedia presentation, through the application of a rule set selected from a plurality of translation rule sets.

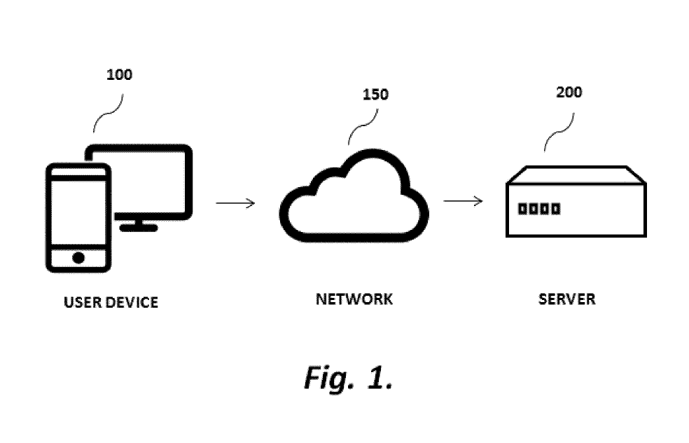

With reference to FIG. 1, a user typically interacts with embodiments of the present invention with a user device 100 which communicates with a server 200 via a computer network 150. The user device 100 can be, for example, a desktop computer, a laptop computer, a smartphone, a tablet, a sketchpad, etc., or a plurality of such devices, that allows the user to draw on a virtual canvas. The server 200 can be, for example, a physical computer or a virtual machine provided by a hosted computing service, or a plurality of such devices working in concert to provide the functionality of the invention. The network 150 may be a direct connection, a local area network, a wide area network, a global network of networks such as the Internet, etc.

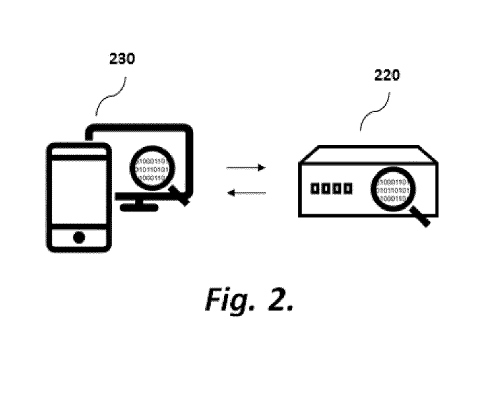

With reference to FIG. 2, embodiments of the present invention provide the functionality described herein utilizing server software 220 executing on the server device(s) 200 and client software 230 executing on the user device(s) 100.

In general, the server software 220 stores and operates on data; performs computations; performs communications between the server software 220 and client software 230 and among various pieces of server software 220 and/or various pieces of server software 230; and performs other actions that support the operation of the invention. Examples of server software products 220 suited to provide the functionality of the disclosed invention include a web server, a network server, a storage server, a messaging server, a computational server, a cache server or other servers that support the operation of the invention.

In general, the client software 230 communicates with the server software 220; communicates with other client software 230′, loads and stores data from the server 200, stores data on a client device 100, assists in visualizing the data, provides a user interface (UI), reacts to user actions, updates data on a client device 100 and on the server 200, and performs other actions that support the operation of the invention. Examples of client software products 230 suitable for use in connection with the present invention include web applications that work in a web browser, downloadable software that can be installed on a user's device 100, software that may come pre-installed on a user's device 100, or other client software that support the operation of the invention.

The client device 100 running the client software 230 opens connections to the server 200 via HTTP, WebSocket, TCP, or any other transport protocol. The client optionally authenticates with credentials (e.g., email and password) to open a session with the server. Within this session, the client requests a list of available documents with action plans, narratives, webpages, etc. and then the particular document requested by a user. The server loads the document from storage into a server memory as discussed in greater detail in the Appendix.

A document may be presented to users in two modes: multi-user real-time mode and single-user mode. In the case of multi-user real-time mode, the server software analyzes the document data and builds an in-memory representation of document. Upon request from the client device, the server transmits a snapshot of the in-memory representation of the document to the client device. At this point, every client device has a synchronized copy of the document.

A user subsequently operates the client device's UI to make changes to the document. Each change is translated into a command for transmission to the server. In one embodiment, after the changes are made and the corresponding commands are transmitted, the client device assumes that the commands are applied temporarily at the server and waits for confirmation from the server to make the changes into the local copy of the document. In another embodiment, the client device displays the changes to the local copy of the document before receiving confirmation, or without awaiting confirmation at all.

The client devices send packets with one or more updates to a document to the server. The server receives each packet from a client and then applies updates from it sequentially to an in-memory representation of the document. After all updates from the packet are applied and all rules from the set of rules are applied, the server gathers all of the changes in a response packet. These changes include the changes from clients' packets and all effects of the applied rules. The response packet is delivered to each connected client device.

Each client device receives the response packet with updates and applies each update permanently to its locally-stored copy of the document. This model preserves the same order of applied updates on the server and on each client device, and preserves the identicality of each copy of the document on each client device and the server.

The server software queues all packets with changes to documents that are received from clients and processes them one by one without parallelization or concurrency. If the server software is implemented, e.g., in Java using Akka Actors technology, then each plan document's in-memory representation can be implemented as an actor and each packet with changes may be delivered to the actor as a message. All packets would naturally form a queue in the actor's mailbox and the actor would process them one-by-one as defined by the nature of actor's lifecycle.

When implemented using Akka Actors, each client's connection to the server may be held and processed by another actor. Such actor may register itself on a document's actor. When client software sends a packet with changes to a document, the connection-holding actor will receive the packet on the server side and then send the packet as a message to the document's actor. The document's actor would process the incoming packet, then form and distribute the response packet to each registered connection-holding actor. The connection-holding actor then will transmit these response packets to a client.

In the case of single-user document editing mode, the server serves the document to the client device in its entirety. The client device applies all user changes to its copy of the document immediately. When the client device is required to save the changes, the client device sends the document data to the server in whole.

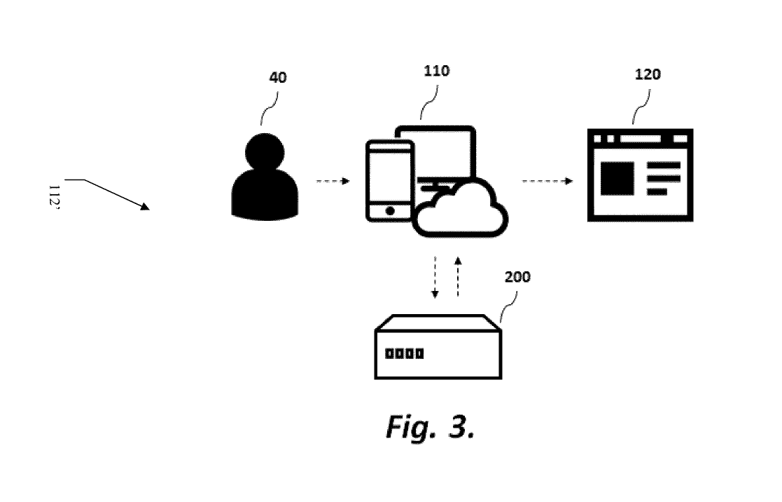

FIG. 3 presents an example of how a user 40 interacts with an embodiment of the invention. The user 40 operates a client device 110 that communicates with the server 200 through a permanent or transient network connection, and through the user interface 120 on the client device either creates a new document or loads such a pre-existing document from the server 200. When loading a pre-existing document, the server 200 transfers the document to the client device 110.

One the client device 110 loads the document into memory, the client UI 120 presents it visually to the user 40. The client software 230 reacts to the actions of the user 40, time-triggered events, notifications and commands from a server 200. The client software 230 exchanges data with the server 200 and other client software 230, updates the visualizations presented to the user and updates the user interface 120, and performs other operations to support the operation of invention. It is possible for each user 40 to have their own account on a server 200 that contains the data associated with the user 40.

With continued reference to FIG. 3, the client UI 120 can be used to provide an interface to an operator that includes a representation of a virtual canvas. The client UI 120 can also be used to receive at least one drawn feature from the operator, the drawn feature coinciding with the presented representation of the virtual canvas. The memory of the client device 110 may store one or more predetermined rule sets. Some of those rule sets may be transforming rule sets, which provide for the transformation of at least one drawn feature into an action plan. Other rule sets may be translating rule sets, which permit the transformation of an action plan into a secondary form, such as a virtual canvas, a task list, a narrative, a webpage, a multimedia presentation, etc. The processor in the client device 110 is configured to apply at least one of the plurality of the predetermined rule sets to transform received drawn features into an action plan, or to further translate the action plan into a secondary form.

Still other rule sets may be action plan rule sets, which describe the structure of an action plan and how a processor should process changes in the action plan. These action plan rule sets may be associated with an action plan and used by the processor to process changes to the action plan.

In some embodiments, the display, receiving, and translation functionality are all included in the user device 110. In other embodiments, the display, receiving, and translation functionality are all offered by the server 200. In still other embodiments, the functionality is divided among several components with, e.g., the display and receiving functionality offered by the user device 110 and the translation functionality offered by the server 200.

The following discussion focuses on an embodiment of the invention that permits a user to create and interact with an action plan, although it is to be understood that the scope of the invention is not limited to this particular embodiment and includes documents of various kinds, as discussed below.

### Action Plan

One of the purposes of the invention is to help users create and edit action plans. Action plans can be helpful to the execution of new undertakings. An action plan typically includes a plurality of actions to be performed to successfully complete the undertaking. First, the action plan is created. Then plan is refined and updated as the plan is executed.

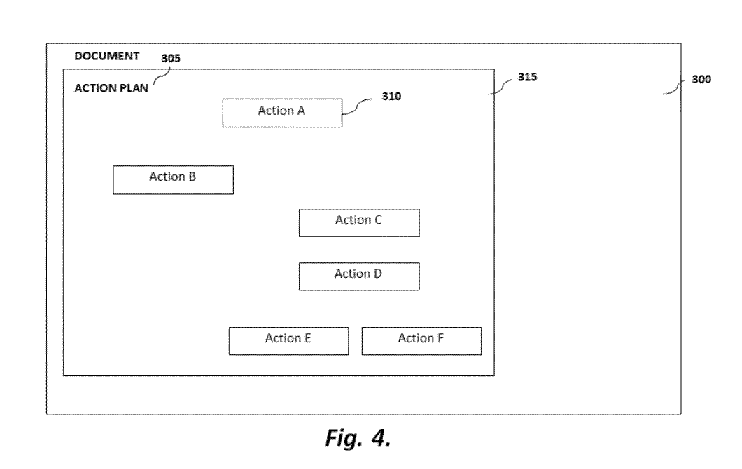

With reference to FIG. 4, each action 310 is a piece of data which describes any possible logical entity that can be planned, such as an activity, task, aim, goal, milestone, stage, state, control point, etc. The action may have a title, description, type, status, state, coordinates, action group identifier, textual or graphical notes, and various properties including dates, deadlines, locations, durations, numbers, amounts, assigned people and any other data. Actions may also contain references to files, URLs, addresses, etc.

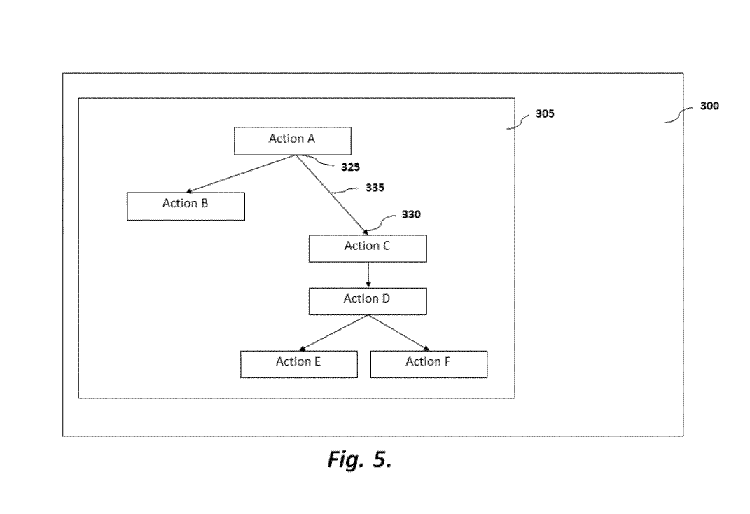

FIG. 5 shows the actions of FIG. 4 with causal relationships 335 defined between the actions 310. Each causal relationship 335 is a piece of data which describes a unidirectional tie between two actions 310 and defines the order in which these two actions are supposed to be executed.

With reference to FIGS. 4 and 5, action plan 305 is a document 300 which includes at least one action and, when the action plan includes at least two actions, the action plan may optionally include at least one causal relationship defined between some of those actions. An action plan 305 may have a title, description, textual or graphical notes, and various properties including dates, deadlines, locations, durations, numbers, amounts, assigned people and any other data. An action plan 305 may also contain references to files, URLs, addresses.

Action plans 305 are presented by a client UI 120 as a two-dimensional space 315 (e.g., a canvas) with actions 310 graphically placed by a user 40 on the space 315. As shown in FIG. 5, there is one top-level space which is visible to a user 40 by default and where all top-level actions 310 are placed.

Causal relationships 335 may represent an order of execution for a sequence of actions. Each relationship 335 has two ends, with one end designating each action in the relationship. When the relationship 335 represents an order of execution, then the end from which the relationship originates 325 can represent the initial action and the other end 330 can represent the immediately following action.

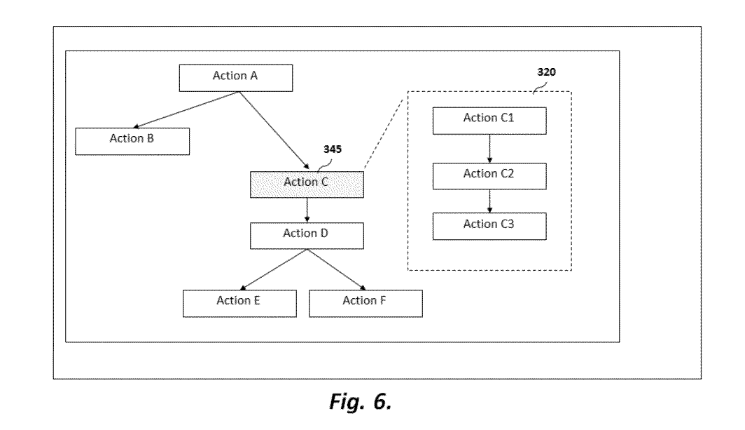

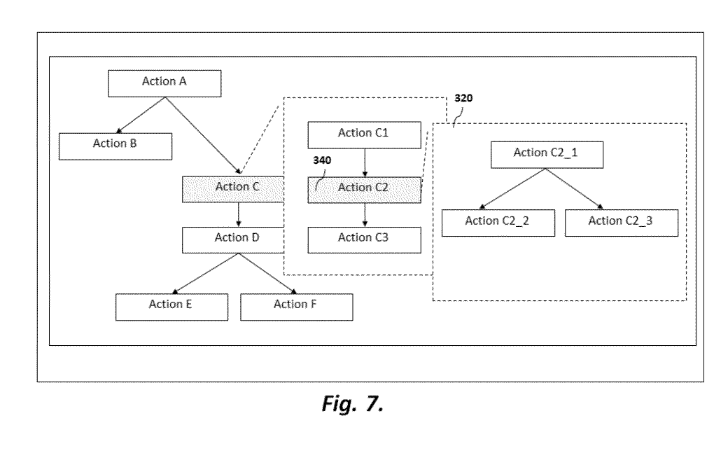

With reference to FIG. 6, an action plan 305 may also be organized into a plurality of canvases. FIG. 6 depicts the top-level canvas 315 of FIG. 5 linked to a lower-level canvas 320. The lower-level canvas 320 contains a plurality of actions and causal relationships therebetween that represent a decomposition of the action 345 appearing in the top-level canvas 315. This functionality allows for the creation of multi-level actions and canvases. As shown in FIG. 7, an action 340 from a lower level canvas may itself be decomposed into one or more actions and causal relationships, and so on.

When the actions contained by the lower-level canvas 320 represent a decomposition of the action 345 appearing in the top-level canvas 315, then all of the actions on the lower-level canvas are automatically associated with the parent action 345. In other embodiments, where the actions contained by the lower-level canvas 320 do not represent a pure decomposition, then at least one of the actions appearing on the lower-level canvas is associated with at least one action appearing on a higher-level canvas.

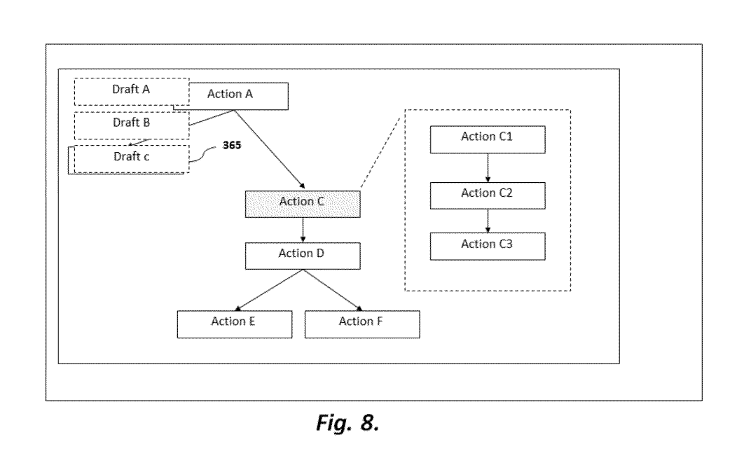

With reference to FIG. 8, while creating an action plan 305, the order and sequencing of a draft action 365 may remain unassigned. The depiction of these draft actions 365 may be differentiated from other actions 345 by showing the draft actions 365 as hovering above the canvas or otherwise located in some kind of dock area.

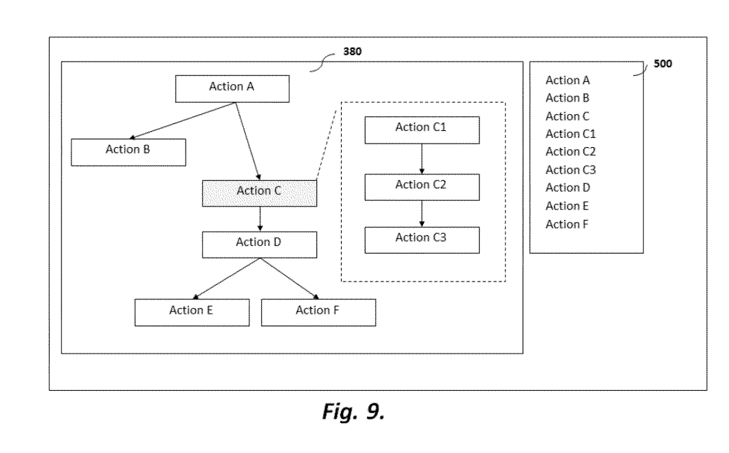

As depicted in FIG. 9, in various embodiments the server software 220 or client software 230 may generate at least one list of actions 500 from an action plan 380 according to some predefined set of rules. For example, the software can use an algorithm which may take into account various action properties. The software can create a personal action list for the current user or a list for any other user that is working on the same action plan. The list may be divided into subsections based on properties of the actions, as discussed in greater detail in the Appendix.

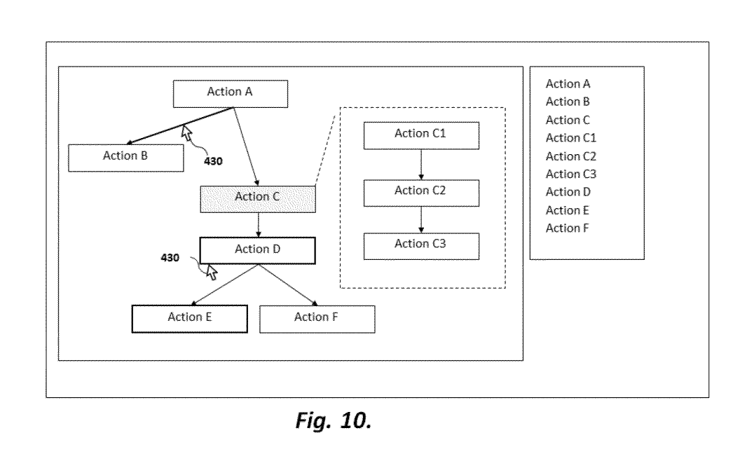

With reference to FIG. 10, depending on the set of permissions, a user may perform various actions on the action plan. A user may create new actions or causal relationships; update some of the properties of existing actions and causal relationships; delete actions and causal relationships; select actions and causal relationships (one by one, or many at once), and update and remove sub-actions from selected actions. On each update to the action plan, the client UI checks and recalculates generated lists of actions if necessary.

Each update may be sent to the server instantly or accumulated in batches and then sent to the server. Some user actions may result in a batch of updates (for example, an update on multiple selected actions will result in an update for every selected action).

Each update may be one of these commands, although the list is not exhaustive: create action, create causal relationship, update action, update causal relationship, delete action, delete causal relationship, change action state, change action type, assign people to action, remove people from action, copy actions to clipboard, and paste actions from clipboard.

These commands are queued and sent in the order in which they occurred. The server receives these commands, applies changes to the data and then distributes the changes to every connected client UI.

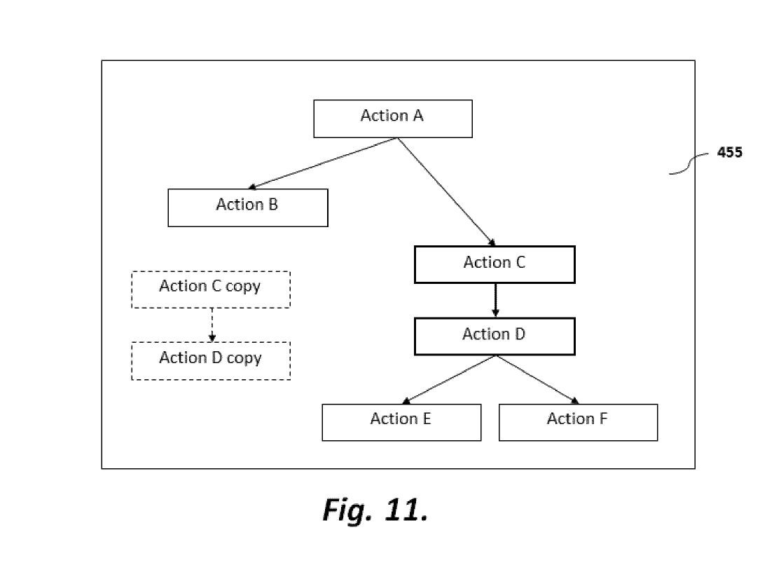

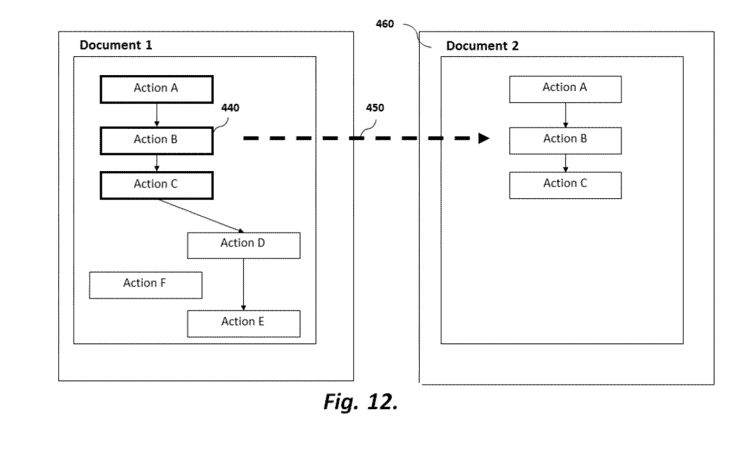

FIG. 11 shows how a user may select one or more actions 440 and copy or cut them to a clipboard and then paste them from clipboard 450 to the same document 455 or to the different document 460. In this case, a request is made from a client device to a server which includes the plurality of actions that should be copied with their corresponding causal relationships to a clipboard. As shown in FIG. 12, this data can then be applied to a second document from the clipboard with a Paste command.

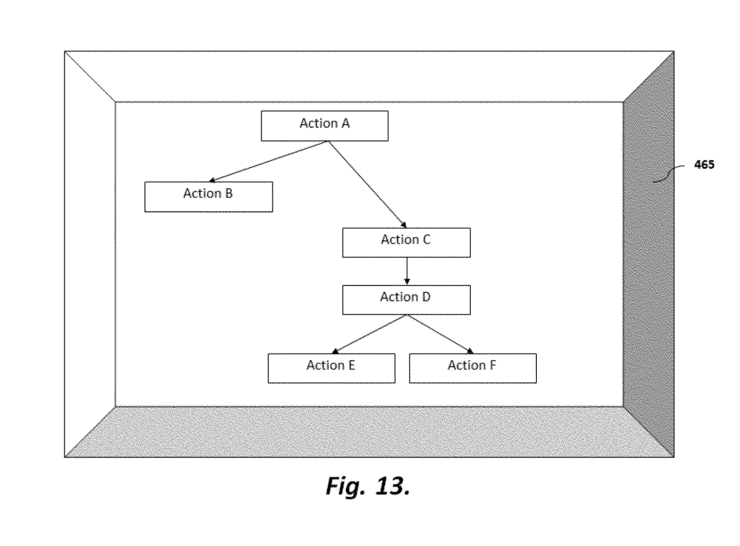

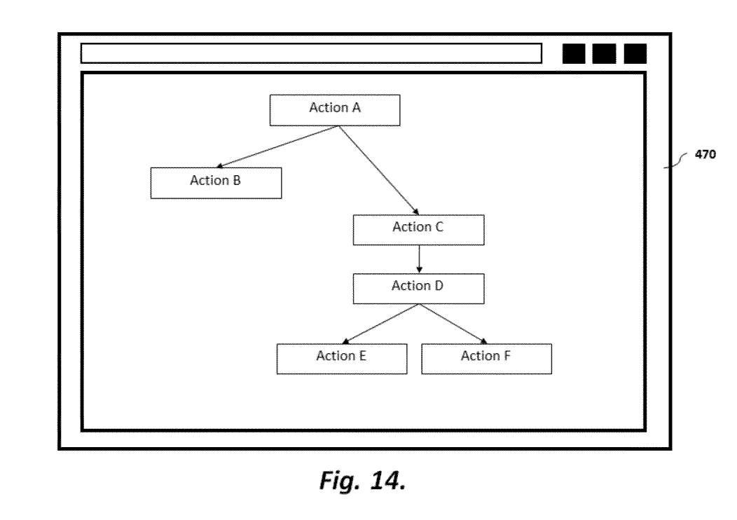

FIG. 13 shows how the action plan document may be saved or exported in various formats: PNG, JPEG, PDF, TIF, GIF, SVG, XLS or any other graphical, document or data format. FIG. 14 shows how the action plan also can be exported in a form of a read-only interactive document which depicts a plurality of two-dimensional spaces (canvases) and allows navigating through the canvases, reading the properties of individual actions.

### Exemplary Action Plan

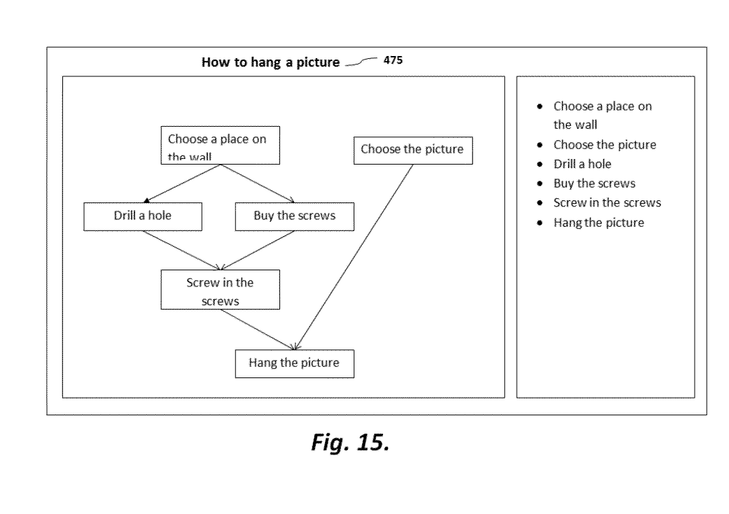

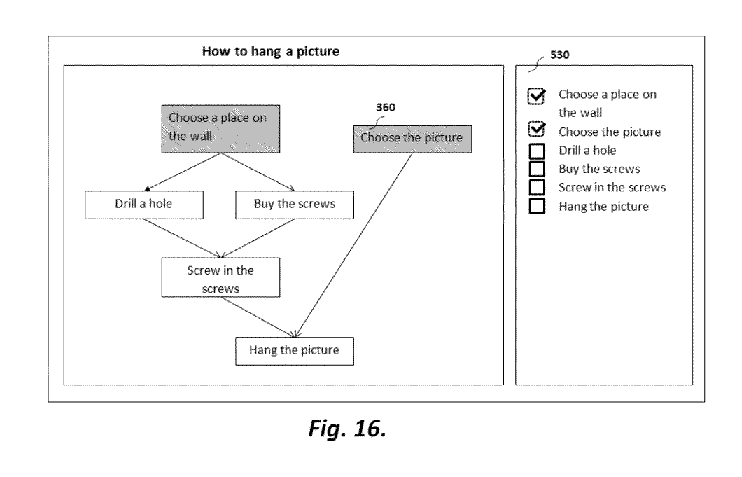

FIG. 15 presents an example of an action plan 475. In this case, a user wants to plan a sequence of actions that will lead her to hanging a picture on the wall. With reference to FIG. 16, each action corresponds to a task 360. The task list 530 corresponds to a generated list of those actions. Each task has one of three statuses: done 480, available for execution 485, and blocked from execution 490.

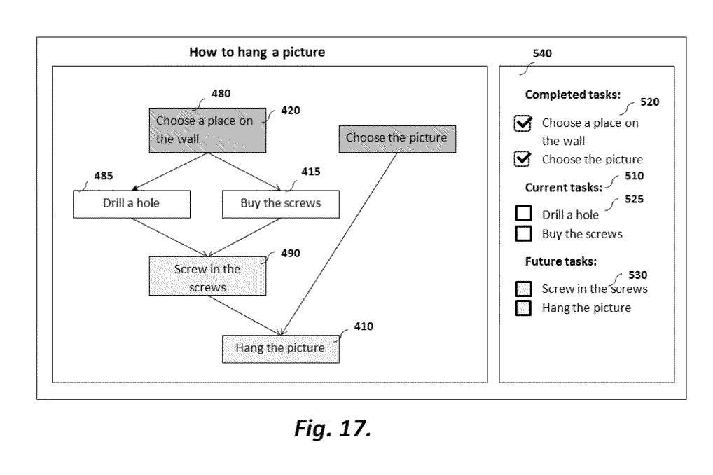

FIG. 17 depicts how this action plan can be organized into subsections. Following a set of predefined rules, the task list is divided into three subsections 540: Completed actions 520, Current actions 525, and Future actions 530. The Completed actions section is filled with actions with state Completed 420 in order of their completion (according to respective property of each Action). Current actions are filled with actions with state Unblocked 415, sorted in order defined by their coordinates on the canvas: actions with lesser vertical coordinates are shown first, and among actions with equal vertical coordinates the ones with lesser horizontal coordinate are show first. Future actions are filled with a list of actions with state Blocked 410. These actions are sorted in approximate order defined by coordinates and causal relationships so actions which might be unblocked first are shown first.

### Second Exemplary Action Plan

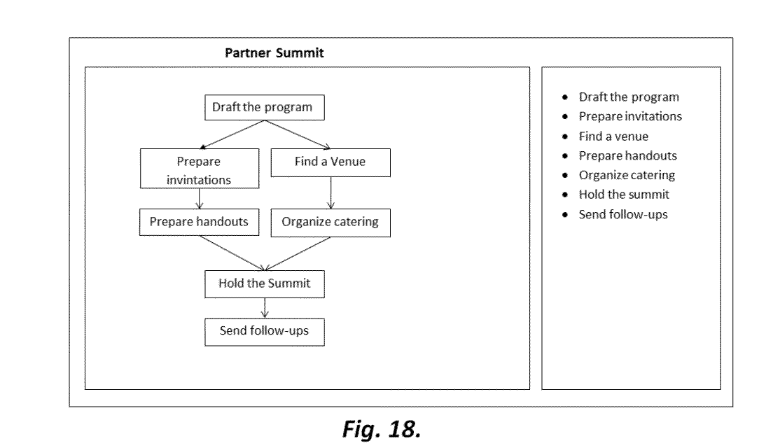

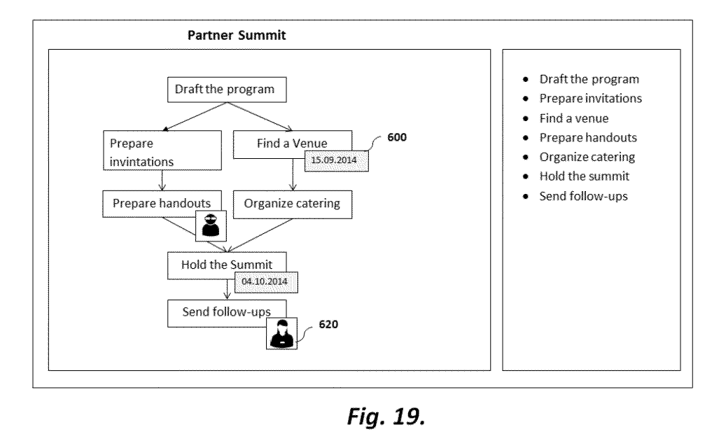

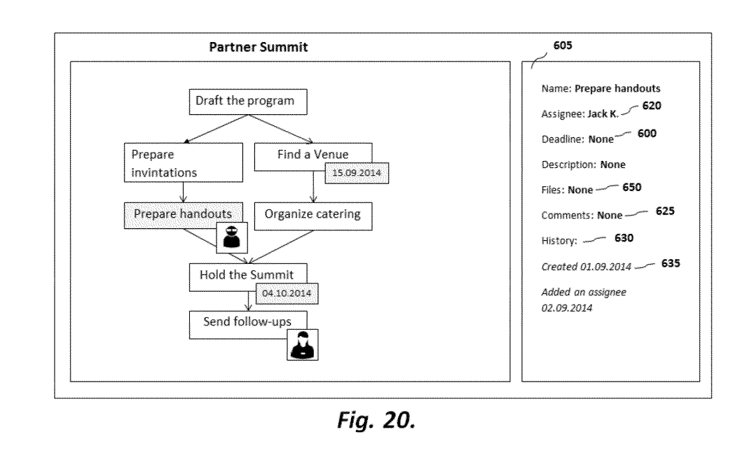

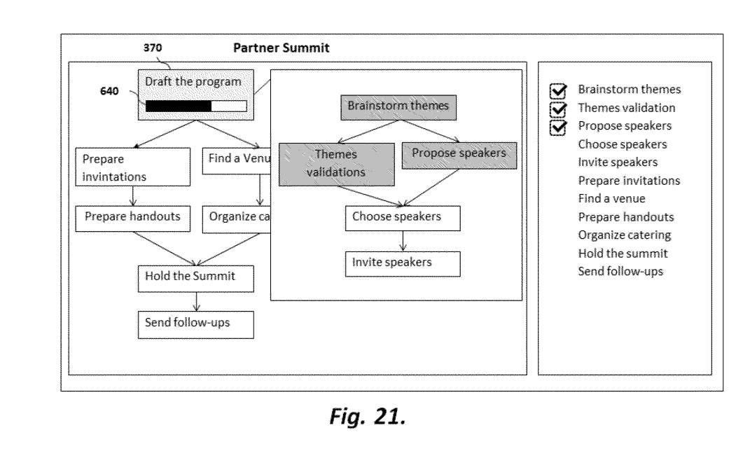

FIG. 18 presents another example of an action plan. FIG. 19 illustrates how the actions in the plan can comprise additional information: deadlines 600 and executors 620. As illustrated in FIG. 20, each action has a set of properties 605 which may be shown in a special section of user interface. Properties may include the name, executor 620, deadline 600, associated files 650, comments 625, the history log 630, date when action was created or changed 635. As presented in FIG. 21, when an action has a lower-level canvas associated with it, then its visualization may include a special colored status bar 640 which indicates the progress of completing actions on the lower level canvas.

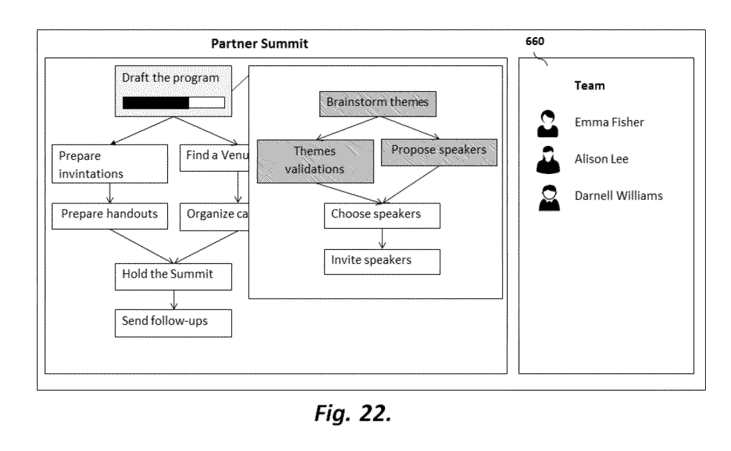

With reference to FIG. 22, the Action plan itself may contain a list of associated users 660. These users may be real users or placeholders for a person. Each user or placeholder for a person may be assigned to an action as an executor of that action.

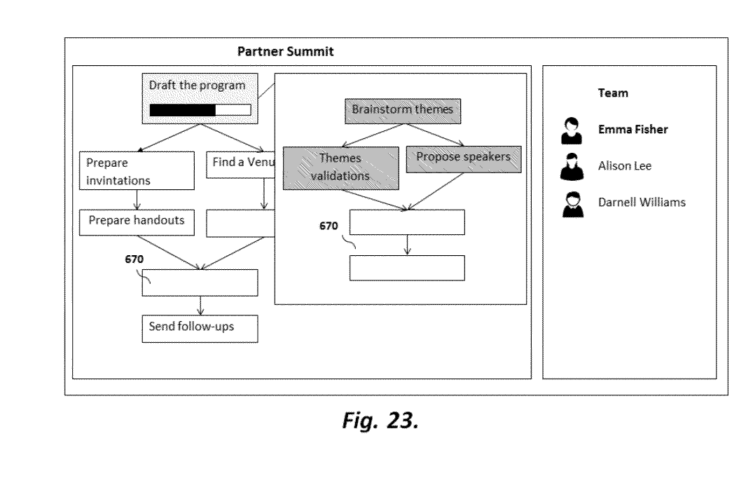

Each user or placeholder may have a role associated with it that defines the set of permissions for this user with respect to the action plan. In accord with the present invention, different users may be presented with different views of a document or lists of actions that differ according to their roles. For example, with reference to FIG. 23, some actions may be hidden from some users 670.

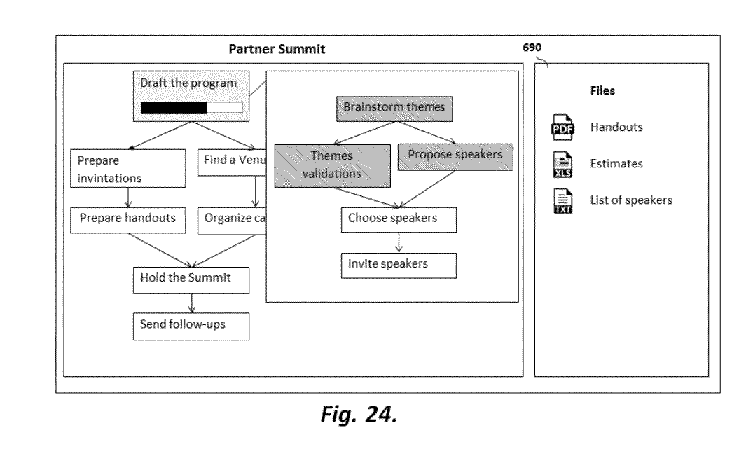

With reference to FIG. 24, action plans and actions may have files 690 associated with them.

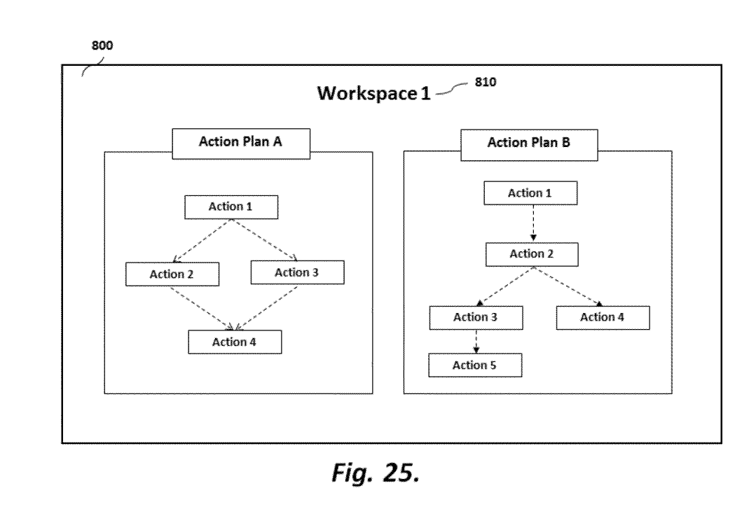

With reference to FIG. 25, action plans and the users who work on these plans may be organized in a workspace 800. A workspace may be assigned to a particular company, organization or a group of people. Workspaces permit action plans to be isolated from access by unauthorized users. Workspaces may comprise various properties 810: name, picture, dates, statuses, etc.

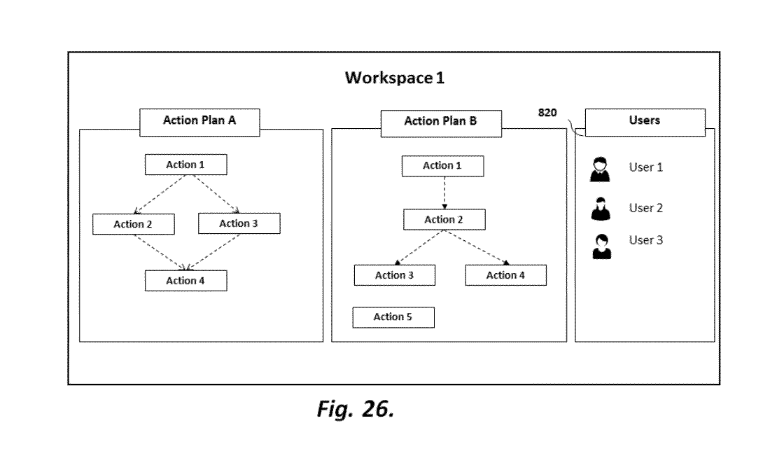

FIG. 26 depicts how each workspace may have users 820 associated with it. Each user may have a different role which affects the permissions for this user in a workspace. The default set of roles and rules is as follows: owner (has all permissions), leader (has all permissions), participant (may edit some action plans but can't create or delete anything), and spectator (may see some action plans but can't edit, create or delete anything).

Each user's record may comprise a unique identifier, name, user name, password and other properties. One user may be associated with multiple workspaces.

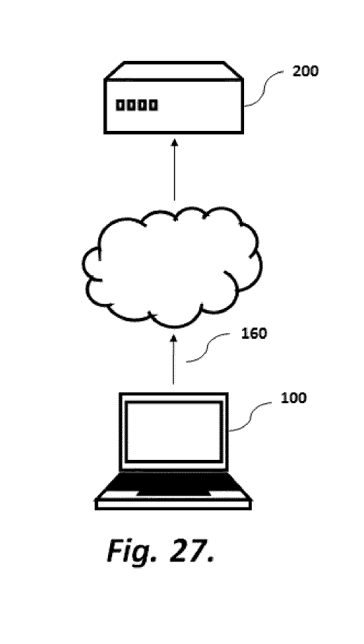

FIG. 27 illustrates the process associated with saving changes to an action plan document. The client device 100 running the client UI software 120 has a connection 160 to a server 200. The document may be presented to users in two modes: a multi-user real-time mode with instant synchronization and a single-user mode with batch synchronization.

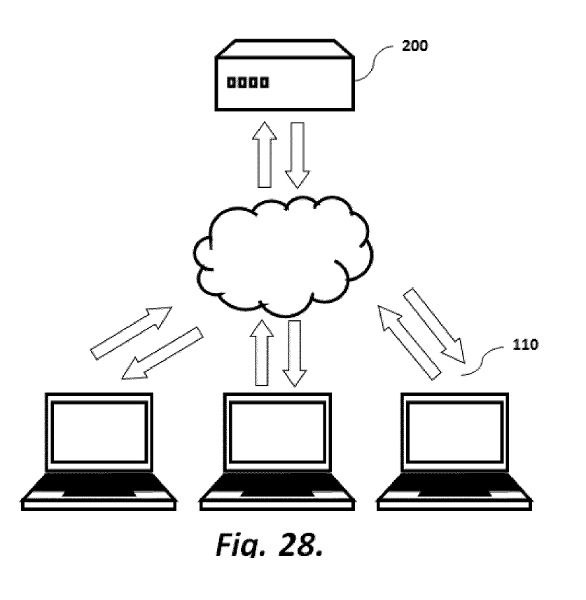

With reference to FIG. 28, in the scenario of instant synchronization of a document, multiple users can simultaneously edit a document on their devices 110. Changes are instantly sent to a server 200 and then distributed to each connected device in the same order to ensure that everyone got a proper most recent version of a document. After the updates are delivered to a device, the device reflects them by updating the visual depiction of the document and regenerating lists of actions.

### Generalized Rule Sets

As discussed above, embodiments of the present invention offer the transformation of drawn features into an action plan. Embodiments of the present invention additionally offer the translation of an action plan into various secondary forms of content, including but not limited to virtual canvases, task lists, narratives, webpages, multimedia presentations, etc.

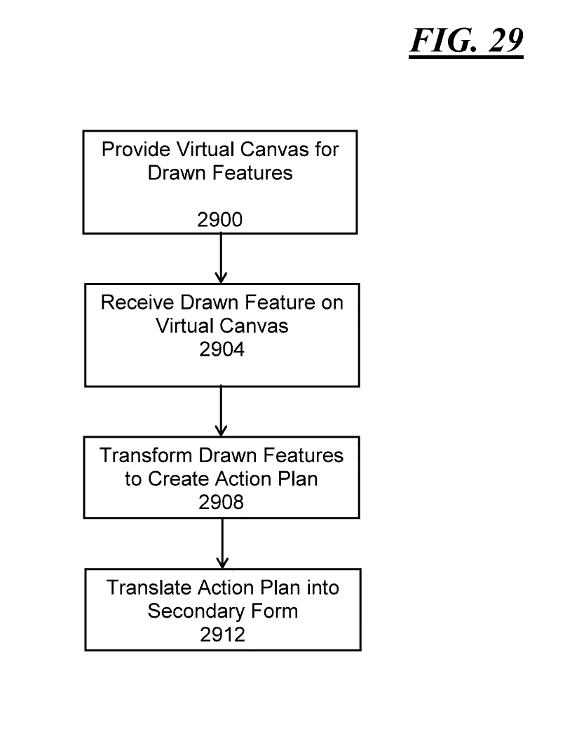

FIG. 29 presents a flowchart of a method for interactive project management in accord with the present invention. The process begins by providing at least one virtual canvas for receiving at least one drawn feature (Step 2900). At least one feature drawn on the at least one virtual canvas is received at the at least one virtual canvas (Step 2904). At least one transforming rule set, typically chosen from a plurality of transforming rule sets, is applied to transform the at least one drawn feature into an action plan (Step 2908). At least one translating rule set, typically chosen from a plurality of translating rule sets, is applied to transform the action plan into one or more secondary forms, such as a task list, a virtual canvas, a narrative, a webpage, a multimedia presentation, etc. (Step 2912).

When the secondary form is a virtual canvas, the translating rule set includes a translating rule creating a virtual canvas receiving drawn features from the action plan, and the application of the translating rule set to the action plan includes the creation of the virtual canvas.

When the secondary form is a task list, the translating rule set includes a translating rule creating a task list from the action plan, and the application of the translating rule set to the action plan includes the creation of the task list.

When the secondary form is a narrative, the translating rule set includes a rule translating the action plan into at least one illustrated text, and the application of the translating rule set to the action plan includes translating the action plan into at least one illustrated text in accord with the rule. Additional text may be received associated with the action plan, and the additional text may be associated with a coordinate pair on the virtual canvas. The rule may include formatting information for the at least one interactive text. When the canvas including the interactive text is associated with another virtual canvas as a sub-canvas, the interactive text of the sub-canvas is associated with at least one text of the associated canvas.

When the secondary form is a web page, the translating rule set includes a rule translating the action plan into a web page, and the application of the rule set to the action plan includes translating the action plan into at least a portion of the web page in accord with the rule. The rule may also include formatting information for at least a portion of the web page.

When the secondary form is a multimedia presentation, the translating rule set includes a rule translating the action plan into a multimedia presentation, and the application of the rule set to the action plan includes translating the action plan into at least a portion of the multimedia presentation in accord with the rule. The rule may also include the definition of graphics, animation, sound, melody, scene, scenario, timing, dynamics, synchronization, or another aspect of multimedia content.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

The description and illustration of one or more embodiments provided in this application are not intended to limit or restrict the scope of the present disclosure as claimed in any way. The embodiments, examples, and details provided in this application are considered sufficient to convey possession and enable others to make and use the best mode of the claimed embodiments. The claimed embodiments should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed embodiments.

### APPENDIX

### Action Plan Default Data Model

By default the following data model is used for a document with action plan. It may be extended or modified with additional properties. Each action is represented with a Java class Task. The Task class has following default set of properties:

String id

String projectId

TaskType type

String name

String description

TaskState state

Long deadline

Integer duration

DurationUnit durationUnit

Long timeCreated

Long timeUnblocked

Long timeStarted

Long timeCompleted

String groupId

String colId

String rowId

String teamId

String creatorId

The Enumerated types mentioned above are TaskType (with default set of values: Task, Draft, Group), TaskState (with default set of values: Blocked, Unblocked, Started, Completed), and DurationUnit (with default set of values: Minutes, Hours, Days, Weeks).

Associations with people are represented with special Java class Executor. The Executor class has following default set of properties:

String id

String projectId

String taskId

String workspaceUserId

Each causal relation is represented with a Java class Transition. Class has following default set of properties:

String id

String projectId

String fromId

String toId

The entire action plan document is represented with a Java class Project. The Project class has following default set of properties:

String id

String name

String description

String workspaceId

### APPENDIX

### Exemplary Action Plan Rule Set

A particular action plan and its data (actions, causal relationships, etc.) data model adheres to a predefined set of rules that may be defined by, e.g., the server software or client software. These rules may be defined to be immutable or customizable by a user, a server administrator, a client administrator, or any other person or company.

One exemplary, non-limiting set of rules provides that:

I. Each action may include the following properties:

a. State property which may have one of following values: Blocked 410, Unblocked 415, Completed 420;

b. Type property which may have one of these values: Task 360, Draft 365, Group 370;

c. Date properties: time when created, time when unblocked, time when completed.

d. Action group identifier

e. Identification of creator

f. Coordinates: vertical and horizontal. Actions are associated with points with these coordinates on one of two-dimensional spaces (canvases).

II. Each causal relationship has two properties that point to the action from which the relationship originates and the action to which it terminates. As defined in relation to the action, each causal relationship can be either outgoing when it originates from the action or incoming if it points to the action.

III. Draft actions have no coordinates and are not assigned to any point of any canvas. These actions are shown only to their creator and are intended to be edited and then converted to a Task action by placing them on some canvas.

IV. By default each action which has Type Task and no incoming causal relationships has a State of Unblocked.

V. By default each action which has Type Group and no incoming causal relationships has a State of Unblocked.

VI. If an action has a State of Unblocked and an incoming causal relationship with the action on the origin side of this relationship has a State not equal to Complete then the State of this action is changed to Blocked.

VII. When an action's state is changed to Complete, then if it has an outgoing causal relationship and the action to which this relationship points has a state of Blocked, then the State of the action to which the relationship points should be changed to Unblocked.

VIII. If an action is assigned to a sub-level canvas then it has a group identifier set to the identifier of the higher-level action with type of Group to which this sub-level canvas is assigned.

IX. If an action has a type of Group and has a sub-level canvas assigned to it and this canvas has sub-level-actions assigned to it, then if the Group action has state Blocked then every action with a state of Unblocked of each sub-level action has to be changed to Blocked.

X. If an action has a type of Group and has a sub-level canvas assigned to it and this canvas has sub-level-actions assigned to it, then if the Group action's state is set to Unblocked then every action with a state of Blocked of each sub-level action has to be changed to Unblocked and then all other rules should apply.

XI. If an action has a type of Group and has a sub-level canvas assigned to it and this canvas has no sub-level-actions assigned to it, then if the Group action's state is set to Unblocked then the Group action's state should be changed to Completed.

XII. If an action has a type of Group with state of Completed and has a sub-level canvas assigned to it and this canvas has no sub-level-actions assigned to it and a user creates a new sub-level action on this sub-canvas, then the Group action's state should be changed to Unblocked.

### APPENDIX

### Exemplary Visualization Algorithm

When a user requests through a client UI to open a document containing an action plan, the plan may be requested from the server or loaded from local storage. When loading the document from a server, server software assembles a document containing a plurality of actions, causal relationships, and additional information, and dispatches the document to a client.

Client UI loads the document into memory and then presents it as follows:

I. The plurality of actions is split into subsets by deciding whether each action is a top-level action or a sub-level action. The decision is made by examining action properties. By default this is done by checking the action group identifier: if it does not exist, then the action is assigned to a top level.

II. Top-level actions are assigned to points on the top-level two-dimensional space (canvas). Sub-level actions are assigned to points on one of a plurality of sub-level canvases. Assigned point coordinates can be obtained from each action's properties. Point coordinates may be absolute, relative or calculated by some predefined formula or a method of calculating of absolute coordinates of a point on a canvas from the properties of an action.

III. When the top-level canvas is shown or any sub-level canvas is shown, the UI renders the action plan for the user:

A. For each action a figure that represents the action is drawn on a canvas at the designated coordinates. A figure may include the title of the action, a deadline, or any other information about action. The figure may be styled or colored according to some properties of action. The default color scheme is:

1. Actions with state Blocked are shown in gray;

2. Actions with state Unblocked are shown in blue and white;

3. Actions with state Completed are shown in green;

4. Actions behind schedule are stylized with a red border.

B. For each causal relationship a figure that represents it is drawn between the respective pair of actions.

IV. After the rendering is completed the UI renders a personal action list for the current user and optionally for each of his colleagues who is working on the same action plan:

A. Action lists are generated according to some algorithm which considers the action's coordinates on the canvas, deadline as well as other properties, and the causal relationships of each action. The list may be divided into sub-sections based on some property. By default this property is the state of an action.

B. Default rules for list generation are:

1. Each list is divided into three subsections: Completed actions 520, Current actions 525, and Future actions 530.

2. First, the Completed actions section is filled with actions with state Completed in order of their completion (according to respective property of each Action)

3. Second, Current actions are filled with actions with state Unblocked, sorted in order by their coordinates on the canvas: actions with lesser vertical coordinates are shown first, and among actions with equal vertical coordinates the ones with lesser horizontal coordinate are show first.

4. Third, Future actions are filled with a list of actions with state Blocked. These actions are sorted in approximate order defined by their coordinates and causal relationships so actions which might be unblocked first are shown first.

What is claimed is:

1. A method for interactive project management, the method comprising:
providing a virtual canvas for receiving at least one drawn feature;
receiving at least one feature drawn on the virtual canvas;
applying at least one of a plurality of transforming rule sets for transforming the at least one received drawn feature into an action plan; and
applying at least one of a plurality of translation rule sets for translating the action plan into a secondary form,
wherein the secondary form is selected from the group consisting of a virtual canvas, a task list, a narrative, a webpage, and a multimedia presentation.

2. The method of claim 1 wherein the secondary form is specific to a user.

3. The method of claim 1 wherein the secondary form is a virtual canvas, and the translation rule set comprises a rule for creating a virtual canvas receiving drawn features from the action plan.

4. The method of claim 1 wherein the action plan is associated with an action plan rule set, the action plan rule set describing the structure of the action plan and how the action plan reacts to changes in the action plan.

5. The method of claim 1 wherein the secondary form is a task list, and the translation rule set comprises a rule for creating a list of tasks from the action plan.

6. The method of claim 1 wherein the secondary form is a narrative and the translation rule set comprises a rule translating the action plan into at least one illustrated text, and the method further comprises translating the action plan into at least one illustrated text in accord with the rule.

7. The method of claim 6, wherein the rule further comprises formatting information for the at least one illustrated text.

8. The method of claim 1 wherein the secondary form is a web page and the translation rule set comprises a rule translating the action plan into a web page, and the method further comprises translating the at least one action into at least a portion of the web page in accord with the rule.

9. The method of claim 8 wherein the rule further comprises formatting information for at least the portion of the web page.

10. The method of claim 1 wherein the secondary form is a multimedia presentation and the translation rule set comprises a rule translating the action plan into a multimedia presentation, and the method further comprises translating the at least one action into at least a portion of the multimedia presentation in accord with the rule.

11. The method of claim 10, wherein the rule further comprises the definition of graphics, animation, sound, melody, scene, scenario, timing, dynamics, synchronization, or another aspect of multimedia content.

12. A system for interactive project management, the system comprising:
an interface configured to provide a representation of a virtual canvas for receiving at least one drawn feature, and further configured to receive at least one feature drawn on the virtual canvas;
a memory configured to store a plurality of translation rule sets, each rule set for translating an action plan into a secondary form;
the memory further configured to store a plurality of transforming rule sets for transforming the at least one received drawn feature into an action plan;
a processor configured to translate the at least one received drawn feature into an action plan by applying at least one of the plurality of transforming rule sets to the at least one received drawn feature; and
the processor further configured to apply one of the plurality of predetermined translation rule sets to translate the action plan into a secondary form,
wherein the secondary form is selected from the group consisting of a virtual canvas, a task list, a narrative, a webpage, and a multimedia presentation.

13. The system of claim 12 wherein the secondary form is specific to a user.

14. The system of claim 13 wherein secondary form is a virtual canvas, and the translation rule set comprises a rule for creating a virtual canvas receiving drawn features from the action plan.

15. The system of claim 12 wherein the action plan is associated with an action plan rule set stored in the memory, the action plan rule set describing the structure of the action plan and how the processor should process changes in the action plan.

16. The system of claim 12 wherein the secondary form is a task list, and the translation rule set comprises a rule for creating a list of tasks from the action plan, and the processor is further configured to translate the action plan into a list of tasks in accord with the rule.

17. The system of claim 12 wherein the secondary form is a narrative and the translation rule set comprises a rule translating the action plan into at least one illustrated text, and the processor is further configured to translate the action plan into at least one illustrated text in accord with the rule.

18. The system of claim 17, wherein the rule further comprises formatting information for the at least one illustrated text.

19. The system of claim 12 wherein the secondary form is a web page and the translation rule set comprises a rule translating the action plan into a web page, and the processor is further configured to translate the action plan into at least a portion of the web page in accord with the rule.

20. The system of claim 19, wherein the rule further comprises formatting information for at least the portion of the web page.

21. The system of claim 12 wherein the secondary form is a multimedia presentation and the translation rule set comprises a rule translating the action plan into a multimedia presentation, and the processor is further configured to translate the action plan into at least a portion of the multimedia presentation in accord with the rule.

22. The system of claim 21, wherein the rule further comprises the definition of graphics, animation, sound, melody, scene, scenario, timing, dynamics, synchronization, or another aspect of multimedia content.
